(19) United States
(12) Patent Application Publication
(10) Pub. No.: US 2013/0316324 A1
(43) Pub. Date: Nov. 28, 2013

(54) SYSTEM AND METHOD FOR MANAGING INTERACTIVE TRAINING AND THERAPIES

(71) Applicant: Marianne HOFFMANN, Carlisle (CA)

(72) Inventor: Marianne HOFFMANN, Carlisle (CA)

(21) Appl. No.: 13/481,330

(22) Filed: May 25, 2012

(51) Int. Cl. G09B 7/00

(52) U.S. Cl. 434/362

(57) ABSTRACT

There is disclosed a system and method for managing applied behavioural analysis (ABA) therapies. In an embodiment, the method comprises: recording a video stream for a training session having a plurality of stimulus-response events; receiving an assessment for each stimulus-response event based on the subject's interaction with or response to the stimulus; time stamping the assessed stimulus-response event in the video stream and identifying the stimulus used at the time of assessing each stimulus-response event; and providing a user interface including one or more of the assessed stimulus-response events for selection.

### FIELD

The present disclosure relates to a system and method for managing interactive training and therapies.

### BACKGROUND

Applied behavior analysis (ABA) methods and techniques are now at the forefront of therapeutic and educational interventions for children with autism. Behavior analysis is the science of behavior, and ABA is the process of systematically applying interventions based upon the principles of learning theory to improve socially significant behaviors to a meaningful degree (Baer, Wolf & Risley, 1968/1987; Sulzer-Azaroff & Mayer, 1991). More specifically, ABA refers to a systematic approach to the assessment and evaluation of behavior, and the application of interventions that alter behavior.

According to the Centre for Disease Control (CDC) Autism Spectrum Disorder (ASD) has grown exponentially from 1 in 10,000 children in 1992 to 1 in 100 today and as high as 1 in 80 boys. In the United States “Approximately 13% of children have a developmental disability, ranging from mild disabilities such as speech and language impairments to serious developmental disabilities, such as intellectual disabilities, cerebral palsy, and autism.” (http://www.cdc.gov/ncbddd/autism/data.html#prevalence). Thus, there is a clear need for effective treatments that can be delivered efficiently.

Over the past 30 years, several thousand published research studies have documented the effectiveness of ABA across a wide range of populations (children and adults with mental illness, developmental disabilities and learning disorders), interventionists (parents, teachers and staff), settings (schools, homes, institutions, group homes, hospitals and business offices), and behaviors (language; social, academic, leisure and functional life skills, self-injury, and stereotyped behaviors).

ABA is an objective discipline focused on the reliable measurement and objective evaluation of observable behavior. Programs based upon ABA methodologies are grounded in the well-established principles of learning and operant conditioning, as influenced by the works of researchers such as Edward L. Thorndike and B. F. Skinner, and Dr. Ivar Lovaas. The use of single case experimental design to evaluate the effectiveness of individualized interventions is an essential component of ABA programs. This process includes the following components which outline a reliable and accountable approach to behavior change (Sulzer-Azaroff & Mayer, 1991): 1) selection of interfering behavior or behavioral skill deficit; 2) identification of goals and objectives; 3) establishment of a method of measuring target behaviors; 4) evaluation of the current levels of performance (baseline); 5) design and implementation of the interventions that teach new skills and/or reduce interfering behaviors; 6) continuous measurement of target behaviors to determine the effectiveness of the intervention, and 7) ongoing evaluation of the effectiveness of the intervention, with modifications made as necessary to maintain and/or increase both the effectiveness and the efficiency of the intervention.

ABA generally focuses on the process of behavior change with respect to the development of adaptive, pro-social behavior and the reduction of maladaptive behavior. Specific “socially significant behaviors” include academics, communication, social skills and adaptive living skills. For example, ABA methods can be used to teach new skills (e.g. the socially significant behaviors listed above); generalize or to transfer behavior from one situation to another (e.g., from communicating with caregivers in the home, to interacting with classmates at school); modify conditions under which interfering behaviors occur (e.g., changing the learning environment so as to foster attention to the instructor); and reduce inappropriate behaviors (e.g., self injury or stereotypy).

In general, this behavioral framework utilizes manipulation of antecedents and consequences of behavior to teach new skills and eliminate maladaptive and excessive behaviors. The Discrete Trial is a particular ABA teaching strategy which enables the learner to acquire complex skills and behaviors by first mastering the subcomponents of the targeted skill. For example, if one wishes to teach a child to request a desired interaction, as in “I want to play,” one might first teach subcomponents of this skill, such as the individual sounds comprising each word of the request, or labeling enjoyable leisure activities as “play.” By utilizing teaching techniques based on the principles of behavior analysis, the learner is gradually able to complete all subcomponent skills independently. Once the individual components are acquired, they are linked together to enable mastery of the targeted complex and functional skill. This methodology is highly effective in teaching basic communication, play, motor, and daily living skills.

Initially, ABA programs for children with autism utilized only Discrete Trial Teaching (DTT), and the curriculum focused on teaching basic skills as noted above. However, ABA programs continue to evolve, placing greater emphasis on the generalization and spontaneity of skills learned. As patients progress and develop more complex social skills, the strict DTT approach gives way to treatments including other components. Specifically, there are a number of weaknesses with DTT including the fact the DTT is primarily teacher initiated, that typically the reinforcers used to increase appropriate behavior are unrelated to the target response, and that rote responding can often occur. Moreover, deficits in areas such “emotional understanding,” “perspective taking” and other Executive Functions such as problem solving skills must also be addressed and the DTT approach is not the most efficient means to do so. Although the DTT methodology is an integral part of ABA-based programs, other teaching strategies based on the principles of behavior analysis such as Natural Environment Training (NET) may be used to address these more complex skills. NET specifically addresses the above mentioned weaknesses of DTT in that all skills are taught in a more natural environment in a more “playful manner.” Moreover, the reinforcers used to increase appropriate responding are always directly related to the task (e.g., a child is taught to say the word for a preferred item such as a “car” and as a reinforcer is given access to the car contingent on making the correct response). NET is just one example of the different teaching strategies used in a comprehensive ABA-based program. Other approaches that are not typically included in strict DTT include errorless teaching procedures and Fluency-Based Instruction.

While ABA therapies can be very effective when delivered properly, a continuing challenge for trainers/therapists and program administrators is how to effectively manage the delivery of ABA therapies in order to increase the likelihood of a successful course of treatment. In prior systems and methods, successful treatment may be left largely to chance based on the level of experience and effectiveness of the trainer/therapist delivering the therapy.

The limitations of existing ABA therapies is also found in various other analogous fields, including training and learning in various different contexts. For example, similar limitations in cost, effectiveness, training and supervision may be found in behavior or performance training applications involving humans or animals, in which it is necessary to deliver the training/therapies more effectively or more cost efficiently.

What is therefore needed is an improved system and method to overcome at least some of the limitations of prior art systems and methods.

### SUMMARY

The present disclosure relates to a system and method for managing various interactive training, which encompasses many types of therapies.

In an aspect, the system provides real-time monitoring of a subject during delivery of a training/therapy session and receipt of real-time input of assessments by trainers/therapists such that the delivery of the training/therapy and the resulting interaction or response of the subject can be recorded for later review and playback.

In another aspect, the system includes a tool for identifying recorded video footage corresponding to a particular point during delivery of a therapy session such that a senior trainer/therapist supervising a therapy session can quickly review and confirm that a therapy has been correctly delivered by a junior trainer/therapist in the field. In an embodiment, a graphical user interface provides access to the recorded video footage of the therapy session by selecting a time stamped event presented in a timeline. The time stamping of an event may be triggered, for example, by an assessment entered by a trainer/therapist who is assessing a subject's response to a stimulus in real time. When an assessment or score is entered, the system and method inserts a tag in the video stream, and also identifies the stimulus that the subject was viewing and responding to at the time the assessment was entered. During playback, the graphical user interface displays the stimuli, and a video segment showing the subject's response to the stimuli as well as the junior trainer/therapist's scoring of the response. Thus, a senior trainer/therapist is able to quickly assess whether the response was correctly graded, and if the junior trainer/therapist is interacting effectively with the subject to help the subject make progress. Based on a real time review of the interaction, the senior trainer/therapist is able to make adjustments to the therapy program and to replace the junior trainer/therapist if necessary to confirm that the subject is continuing to make progress.

In another embodiment, the system provides an immediate way to communicate significant moments during the therapy to supervisors, to allow for immediate direction and instructions. For example, the communication may occur via an instant messenger or videoconferencing application (e.g. Messenger/Skype).

In another embodiment, the system provides a tool to organize scheduling and invoicing to improve the efficient use of a trainer/therapist's time. This would to permit trainers/therapists to service more children in an industry suffering from a significant shortage of qualified interventionists. Improved efficiency of program delivery also decreases the overall costs of a program making it more affordable for parents and guardians.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a schematic diagram of a system architecture in accordance with an illustrative embodiment.

FIG. 2 shows a schematic diagram of a content creator module in accordance with an illustrative embodiment.

FIG. 3 shows a schematic diagram of a user interface screen for creating new content in accordance with an illustrative embodiment.

FIG. 4 shows a schematic diagram of a user interface screen for creating a new deck in accordance with an illustrative embodiment.

FIG. 5 shows a schematic diagram of a user interface screen for creating a new therapy program in accordance with an illustrative embodiment.

FIG. 6 shows a schematic diagram of a window for selecting a deck from a plurality of decks available from a library in accordance with an illustrative embodiment.

FIG. 7 shows a schematic diagram of a clinical assistant module for viewing team data and viewing a therapist's information in accordance with an illustrative embodiment.

FIG. 8 shows a schematic diagram of a user interface screen for displaying therapy information for a subject in accordance with an illustrative embodiment.

FIG. 9 shows a schematic diagram of a user interface screen for displaying additional therapy information for a subject in accordance with another illustrative embodiment.

FIG. 10 shows a schematic diagram of a session planner module in accordance with an illustrative embodiment.

FIG. 11 shows a schematic diagram of a user interface screen for displaying session information for a subject in accordance with an illustrative embodiment.

FIG. 12 shows a schematic diagram of a calendar for scheduling sessions in accordance with an illustrative embodiment.

FIG. 13 shows a schematic diagram of a library containing a plurality of sessions in accordance with an illustrative embodiment.

FIG. 14 shows an illustrative graph of performance by the subject based on the trainer/therapist who worked with the subject.

FIG. 15 shows a schematic diagram of a session execution module in accordance with an illustrative embodiment.

FIG. 16 shows a schematic diagram of a user interface screen for showing the sessions to be undertaken by a subject in accordance with an illustrative embodiment.

FIG. 17 shows an illustrative example of a session program in accordance with an embodiment.

FIGS. 18A and 18B show illustrative stimuli with various interactive features.

FIGS. 19A and 19B show other types of illustrative stimuli with various interactive features.

FIG. 20 shows a schematic block diagram of an application services platform in accordance with an illustrative embodiment.

FIG. 21 shows a schematic block diagram of an operating system platform and tools in accordance with an illustrative embodiment.

FIG. 22 shows a schematic diagram of a generic computing device in accordance with an illustrative embodiment.

### DETAILED DESCRIPTION

As noted above, the present disclosure relates to a system and method for managing interactive training. As an illustrative example, the present system and method may be used for managing the delivery of applied behavior analysis (ABA) therapies for developmental disabilities such as Autism Spectral Disorders or ASD. However, the present system and method is not limited to ABA therapies, and may be extended to include other types of training or therapies in which an assessment is made of a subject's response to a stimulus, and the training/therapy is recorded by video.

In an aspect, the system and method includes a multimedia player to display many forms of stimuli or learning tools while allowing a trainer/therapist to assess or score progress or performance of a subject or end user. The multimedia player also includes engines that allow for customization of applications. The system and method records what happens after the presentation of stimuli or question to a subject, and with a simple user interface, such as a touch screen or remote, an assessment (e.g. grade/score/measurement) of a response (e.g. correct answer/progress/completion/ability) is captured in a comprehensive way.

In an illustrative embodiment, the captured data may include date, time, assessment (e.g. score), location (e.g. GPS based), video of a subject's interaction, the stimulus used to effect the response (e.g. what the subject saw, heard, or felt), and the teacher/therapist/trainer that provided the training/therapy. This metadata is correlated or time-stamped to a particular location in the video stream. All of this metadata can be retrieved by selecting an assessment of a stimulus-response event to provide a comprehensive playback of the training/therapy session. As an illustrative example, the metadata may be accessed through a graph of scores, a chart of weekly scores, the performance of a therapist, all points from a specific date, time or location, etc.

The data is viewable remotely, such that a training/therapy session may be supervised from across the country or virtually anywhere around the world.

In an aspect, the present system and method addresses the full cycle of ASD case management which may appeal to each stakeholder from parent/guardian to trainer/therapist, and from a funding agency to a managing psychologist. In doing so, stakeholders each receive significant value as it pertains to their business, their time and the effectiveness of their interaction with the subject.

In an embodiment, the system and method drives real time collaboration and reporting by increasing the efficiency of on-site trainers/trainers/therapists spending one-on-one time with the subject. Improved efficiencies allows for more funded hours to be used in one-on-one interaction, rather than administration. The system and method provides funding agencies and government with visibility into the ROI on their investment into the patients progress.

In an embodiment, the system and method significantly reduces the number of hours used to conduct team meetings attended by highly paid contributors to the team. One senior trainer/therapist can thus oversee the work of a number of junior trainers/therapists with significantly improved efficiencies. Table A, below, illustrates some of the inefficiencies in prior art systems.

TABLE A

| | |
|---|---|
| Team meetings 1-2 times per month used | The product has been designed for the whole |
| to address issues that occurred (costly | ABA team to participate in the intervention on a |
| $500-700 meeting, sum(persons/rate/hrs) | daily basis |
| Paper and Pencil, using a or on a column | Trainers/therapists will use the touch screen |
| tally sheet | technology to capture the data |
| Some video is taken using phones and | Supervisors and para-professionals will use the |
| video cameras, however they take a cluster | client management web interface to review |
| of time and need to be reviewed by fast- | important messages and events, illustrated by a |
| forwarding and rewinding | cluster of multi-media data specific to each |
| | program |
| Trainers/therapists are supervised 4-8 | Response to significant events can be sent from |
| times per month ($$$), by senior | supervisors to interventionist within a 24 hour |
| trainers/therapists. This allows for | period vs. waiting for costly team meetings, that |
| inappropriate methods being used multiple | usually occur 1-2 times per month |
| times before being corrected, which can | |
| cause problems with the program, confuse | |
| the child, and delay mastery of skills. | |

In another aspect, the system and method also encourages a more natural interaction with the patient by using touch technologies, and allows a trainer/therapist to create custom training/therapy aids for each patient while greatly reducing the amount of preparation time. This makes therapy programs more efficient, allowing governments to service more patients on waiting lists, which continues to be a serious problem.

Thus, the present system and method is directed to reducing the costs of managing an ABA program by increasing program efficiency, increasing effectiveness of the intervention, and allowing for a true collaboration amongst the intervention team members which may normally include one or more of speech trainers/therapists, clinical supervisors, senior trainers/therapists, instructor trainers/therapists, occupational/physical trainers/therapists, and administrators or an agency.

Children can be removed from a program based on a “clinical decision” by a psychologist who has never met the child and has only reviewed poorly constructed reports based on standardized testing designed for neuro-typical children. In contrast, the present system and method allows the capture of numerous unique points of data (i.e. numeric, video, image, time, date, and trainer/therapist) to illustrate the true picture of the event. The present system and method enables the review of flexible data that not only measures the child's participation but also the program and trainers/therapists as a collective. This timely, collaborate review ensures that the child is not held solely responsible for any lags in developmental gains that could be a direct result of the team's performance (i.e. inappropriate programming, or inappropriate teaching methods). Thus, the present system and method helps a child demonstrate his/her true potential, and successfully guides their participation in an ABA program.

One aspect of the present system and method is a capture tool that harnesses a cluster of dynamic media data that is time stamped and specific to a certain skill or behavior of a subject, such as a child. The present system and method captures and illustrates a child's current abilities at the exact moment of an interaction and response to a stimuli, and can entirely replace the need for interpretation of anecdotal comments without any further supporting evidence, or testing not suitable for the child with special needs.

In another aspect, the present system and method provides an easy to use instruction design tool for educators, parents, and other trainers/therapists, and will allow intervention therapies to become more affordable and available to children in need of treatment.

The system and method will now be described in more detail with reference to the drawings.

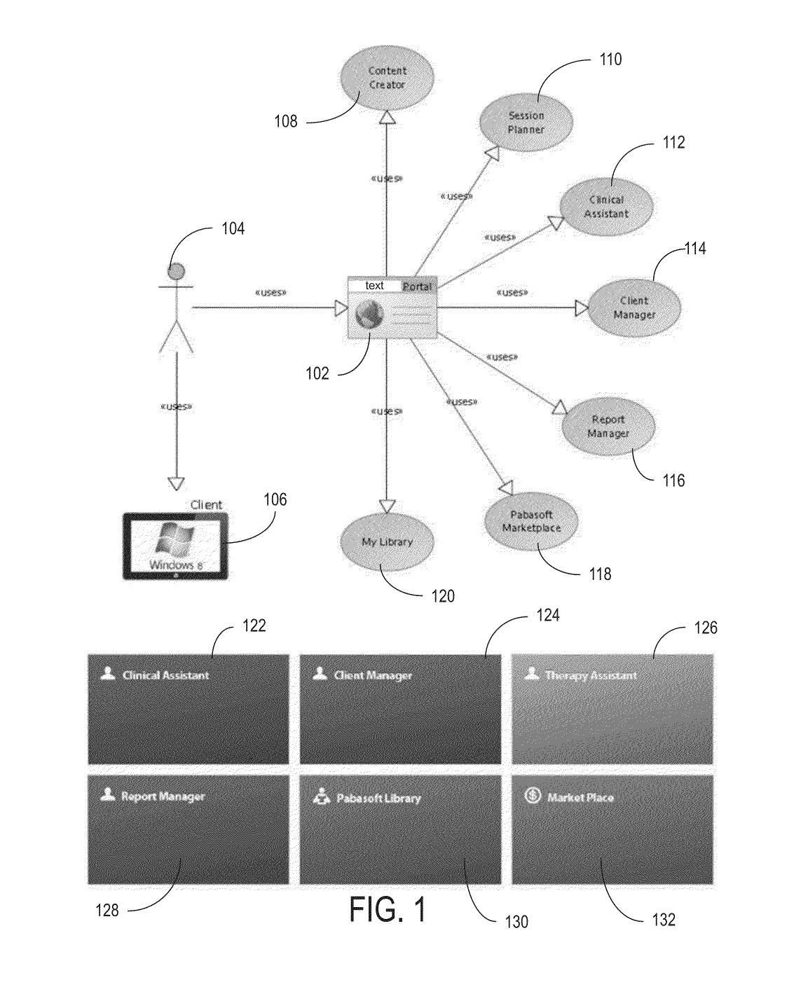

FIG. 1 shows a schematic diagram of a system architecture in accordance with an illustrative embodiment. As shown, FIG. 1 includes an Internet application portal 102 which may be accessed by a user 104 via a suitable application client module 106 which may be running on a desktop or mobile computing device. The Internet application portal 102 provides access to a plurality of modules including a content creator 108, a session planner 110, a clinical assistant 112, a client manager 114, a report manager 116, an online marketplace 118 and a library 120. These various modules may be accessible via buttons 122-132 selectable via a pointing device or via a touch screen interface, for example.

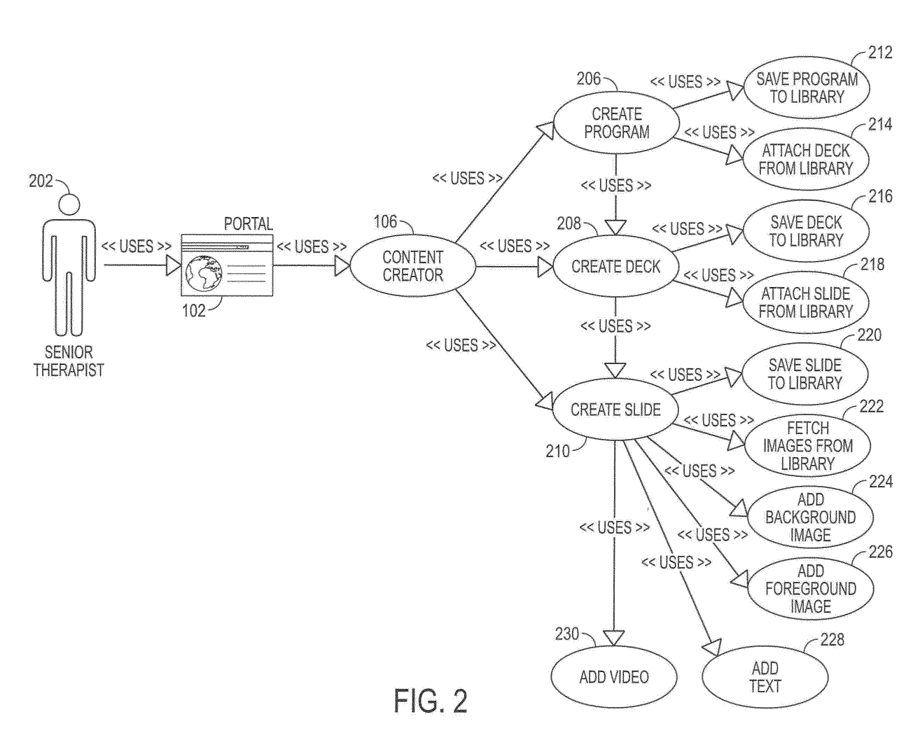

Now referring to FIG. 2, shown is a schematic diagram of a content creator module 106 in accordance with an illustrative embodiment. As shown, content creator 106 may access various sub-modules including a create program sub-module 206, a create deck sub-module 208, and a create slide sub-module 210. Create program 206 may access a save program to library routine 212, and an attach deck from library routine 214. Create deck 208 may access a save deck to library routine 216 and an attach slide from library routine 218. Create slide 210 may access a save slide to library routine 220, fetch image from library routine 222 and an add background image routine 224. Create slide 210 may further access an add foreground image routine 226, and add text routine 228, and an add video routine 230. By providing an easy to use content creator, the present system creates programs to be delivered in an effective and cost efficient manner.

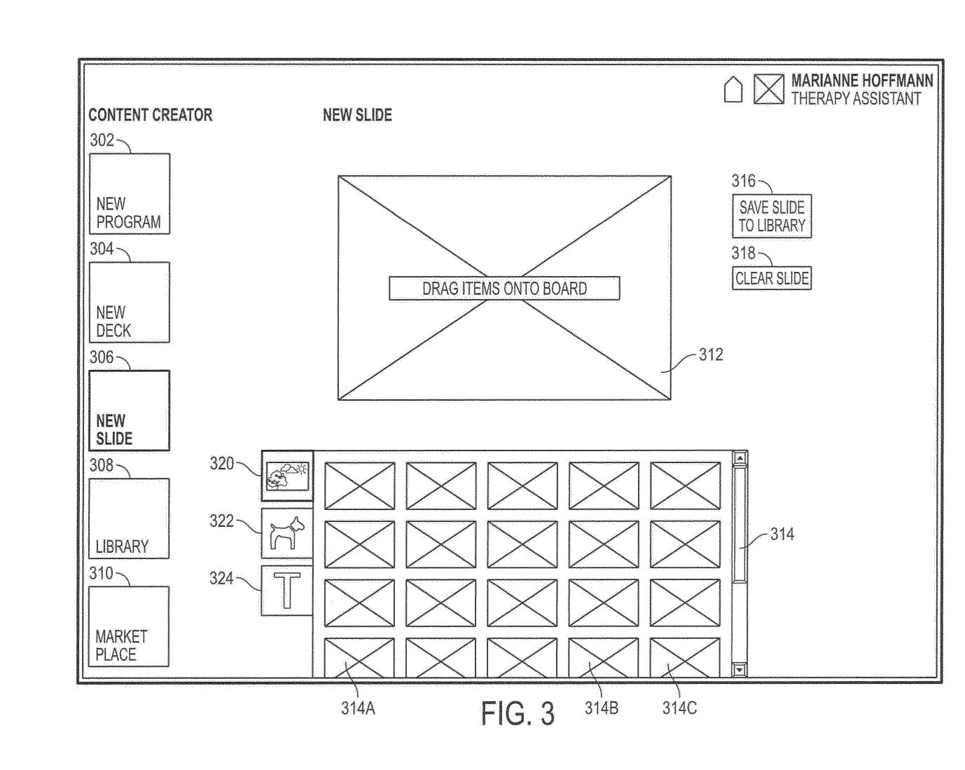

FIG. 3 shows a schematic diagram of a user interface screen for creating new content in accordance with an illustrative embodiment. The user interface screen may include various selectable routines including new program 302, new deck 304, new slide 306, access library 208, and access marketplace 210. In this illustrative example of a routine for creating new slides 306, a database 314 containing a plurality of items 314A-314C may be selected and dragged onto a board 312. Selection of a number of items onto the board may create a slide which may be saved to a library ay 316 or cleared from the board 318 in order to create a new slide. Various categories of items may be selected via icons 320, 322 and 324, for example.

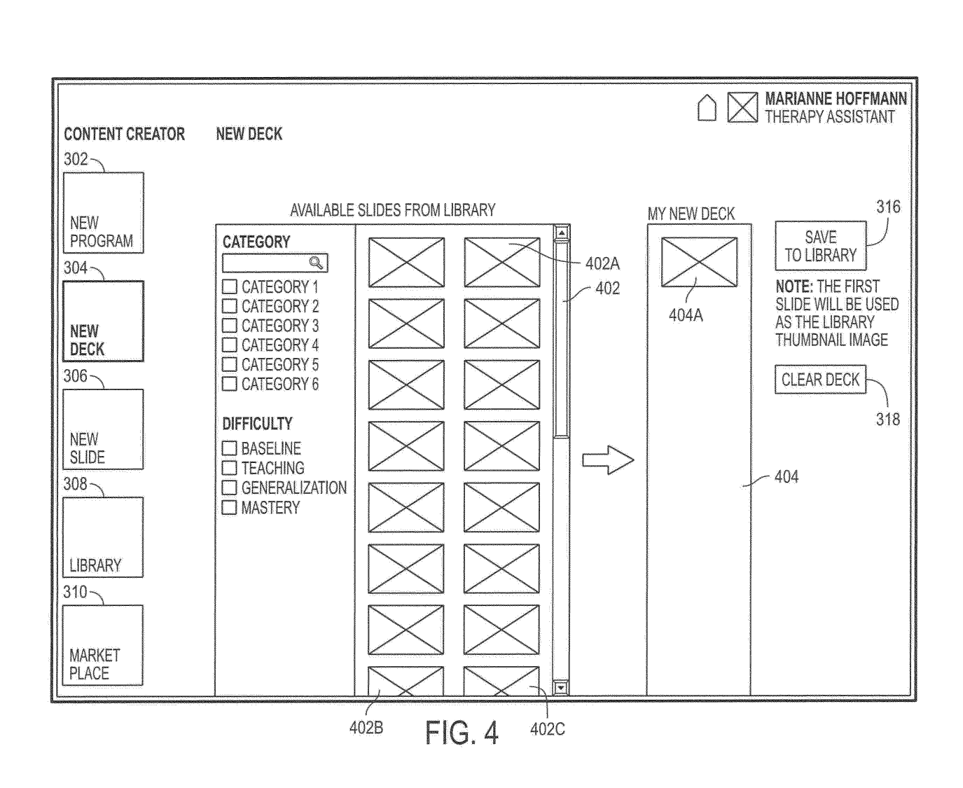

FIG. 4 shows a schematic diagram of a user interface screen for creating a new deck in accordance with an illustrative embodiment. As shown, a library 402 containing various available slides 402A-402C may be provided to allow a user to select one or more slides 402A-402C to create a new deck 404. As shown, deck 404 presently contains slides 404A.

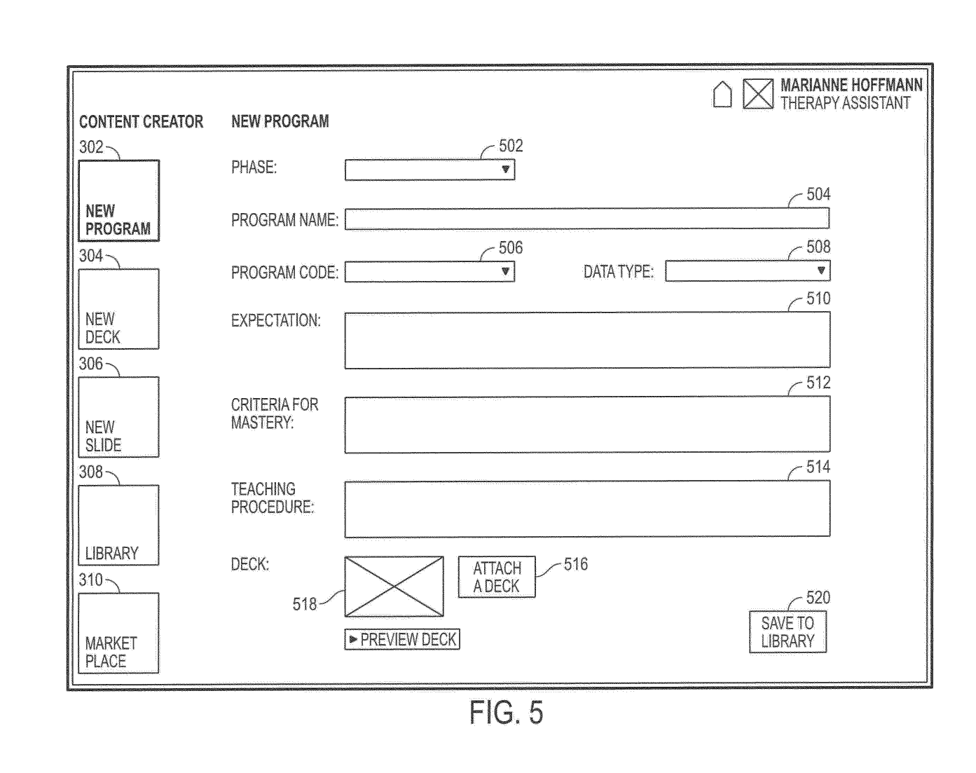

FIG. 5 shows a schematic diagram of a user interface screen for creating a new therapy program in accordance with an illustrative embodiment. As shown, the user interface screen includes a phase drop down menu 502, a program name field 504, a program code drop down menu 506, a data type drop down menu 508 and various fields for describing expectations 510, criteria for mastery 512, and teaching procedure 514. A deck of items 516 may be attached to the new program, and a review window 518 may provide a preview of the items in the deck. Once created, the new program can be saved to the library at 520.

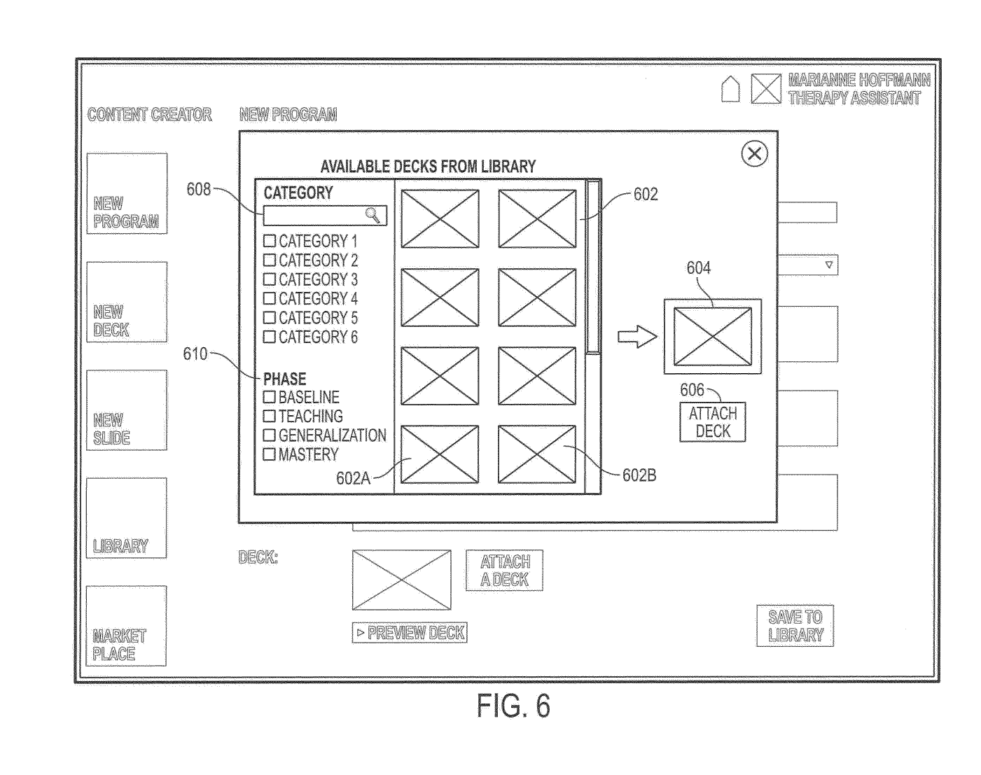

FIG. 6 shows a schematic diagram of a window for selecting a deck from a plurality of decks available from a library in accordance with an illustrative embodiment. Available decks 602A, 602B etc. shown in window 602 may be selected at 604 and attached at 606. Various categories 608 and phases 610 may specify which decks are made available for selection.

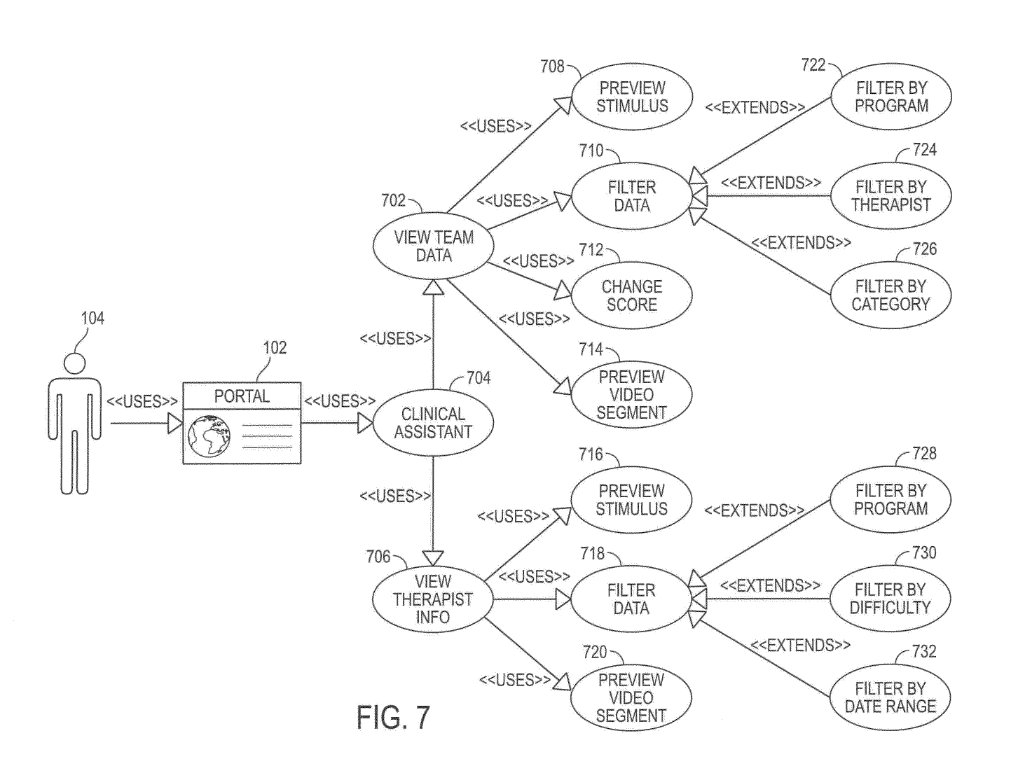

FIG. 7 shows a schematic diagram of a clinical assistant module for viewing team data and viewing a trainer/therapist's information in accordance with an illustrative embodiment. As shown, user 104 (e.g. a senior trainer/therapist or supervisor) can use Internet application portal 102 to access a clinical assistant 704 for viewing team data 702 and viewing trainer/therapist information 706. When viewing team data at 702, the user can preview the stimulus at 708, filter data at 710, change a score 712 and preview a video segment of the interaction at 714. Filtering data at 712 may be by program 722, by trainer/therapist 724, or by category 726.

Still referring to FIG. 7, for viewing trainer/therapist information at 706, the user may preview the stimulus 716, filter data at 718, and preview a video segment of the interaction at 720. Filtering data at 718 may be by program 728, by difficulty 730, or by date range 732.

As will be appreciated, FIG. 7 allows a senior trainer/therapist to efficiently review the interactions of a subject and a trainer/therapist, and correct any scores that were entered incorrectly based on a review of the stimulus and a preview of the video segment of the particular point in the interaction.

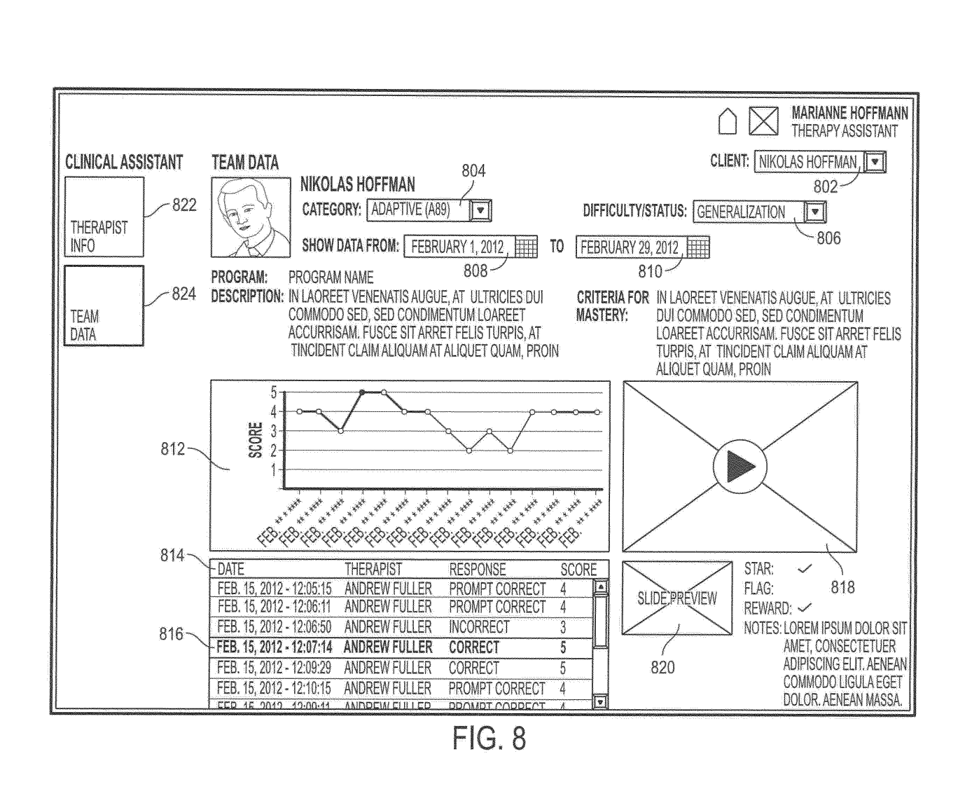

FIG. 8 shows a schematic diagram of a user interface screen for displaying therapy information for a subject in accordance with an illustrative embodiment. As shown, a subject 802 may be currently associated with a category 804 and a particular difficulty or status 806. Date entry fields 808, 810 for specifying a date range for subject data. A graph 812 may show a score (e.g. between 1 and 5) for each therapy session as entered by a trainer/therapist. The score may reflect whether the subject correctly or incorrectly responded to a particular stimulus, and whether the subject was prompted or not before providing a response. Particulars of a session may be shown in a chart at 814, and a specific therapy session may be highlighted to obtain more detained information. A video window 818 may show a recorded video clip of the particular point in time when the interaction occurred, such that therapy supervisor can review the entire interaction between the subject and the trainer/therapist to determine if the response was correctly scored. Additional trainer/therapist information may be accessed via button 822, and team data may be accessed via button 824.

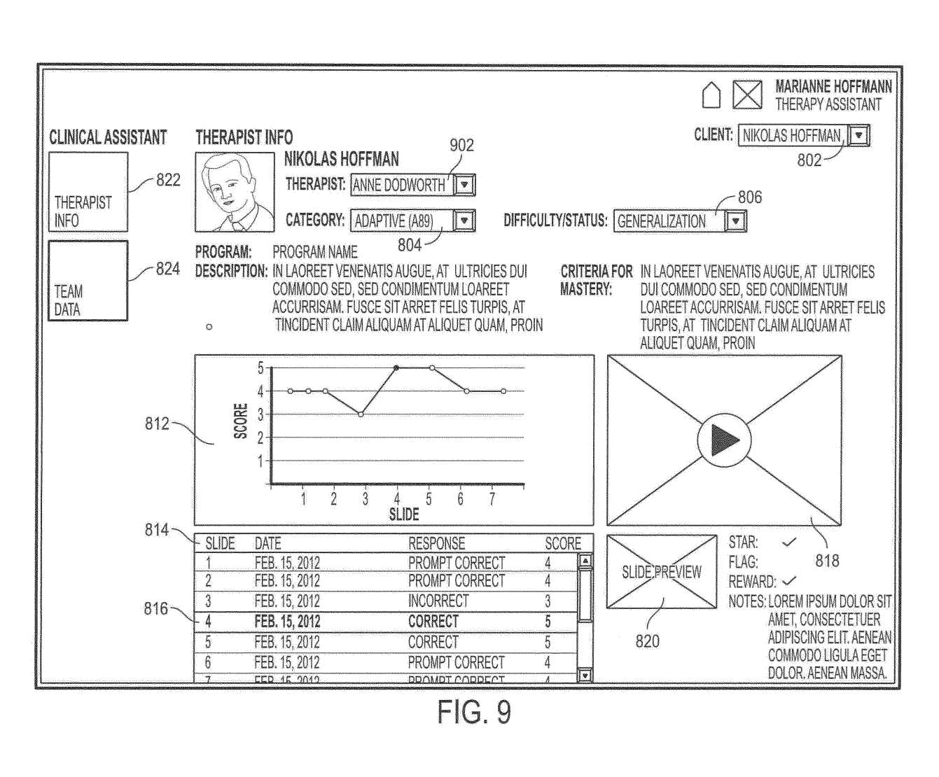

Now referring to FIG. 9, shown is a schematic diagram of a user interface screen for displaying additional therapy information for a subject in accordance with another illustrative embodiment. In this example, for subject 802, the interactions with a particular trainer/therapist 902 can be detailed, as shown in graph 812, and in chart 814. A particular therapy session highlighted at 816 may be selected in order to view a recorded video session in window 818. A preview of the particular stimulus seen by the subject may also be displayed at 820.

As noted above, the present system and method provides a tool for readily identifying recorded video footage corresponding to a particular point during delivery of a therapy session such that an off-site or remotely located senior trainer/therapist or clinical supervisor supervising a therapy session can quickly review and confirm that a therapy has been correctly delivered by an on-site trainer/therapist, typically a more junior trainer/therapist, in the field. In an embodiment, an interactive graphical user interface provides access to the recorded video footage of a therapy session showing the response of a subject in response to a stimulus by selecting a time stamped event presented in a timeline. The time stamping of an event may be triggered, for example, by a score entered by a junior trainer/therapist who is interacting with and grading the subject's response to a stimulus in real time. When a score is entered, the system and method inserts a tag or a flag in the video stream, and also identifies the stimulus that the subject was viewing and responding to at the time the score was entered. Alternatively, the system and method can record the stimulus being used at a given time, and the changes in stimuli being used over time, such that tagging a point in the video stream may automatically identify the stimulus that was used at the time. Furthermore, the location of the therapy session is recorded in order to take into account the environment in which the subject was receiving the therapy session. For example, if the subject consistently performs better in one environment than another, the program may be altered such that the subject receives therapy sessions exclusively in a given environment to help speed up progress.

Typically, because the scoring of a response will occur at the end of a stimulus-response event, the tagging may identify the end of the video stream for that event. Therefore, by selecting a time stamped event in a timeline, instead of queuing the video at the exact point in time the scoring was entered, the system and method may determine when the stimulus-response event began by determining when the stimulus was first displayed. Therefore, the video can be immediately queued to the beginning of the stimulus-response event for review by the senior trainer/therapist or clinical supervisor.

During playback, the graphical user interface displays the stimuli, and a video segment showing the subject's response to the stimuli as well as the junior trainer/therapist's scoring of the response. The location of the therapy session, and the on-site trainer/therapist who graded the responses is also displayed. Thus, by reviewing a recorded event triggered by a grade entered in real time, a senior trainer/therapist is able to quickly assess whether the response was correctly graded, and if the junior trainer/therapist is interacting effectively with the subject to help the subject make progress. Based on a real time review of the interaction, the senior trainer/therapist is able to make adjustments to the therapy program as may be necessary and may provide feedback to the on-site trainer/therapist if necessary to assist the subject with making progress.

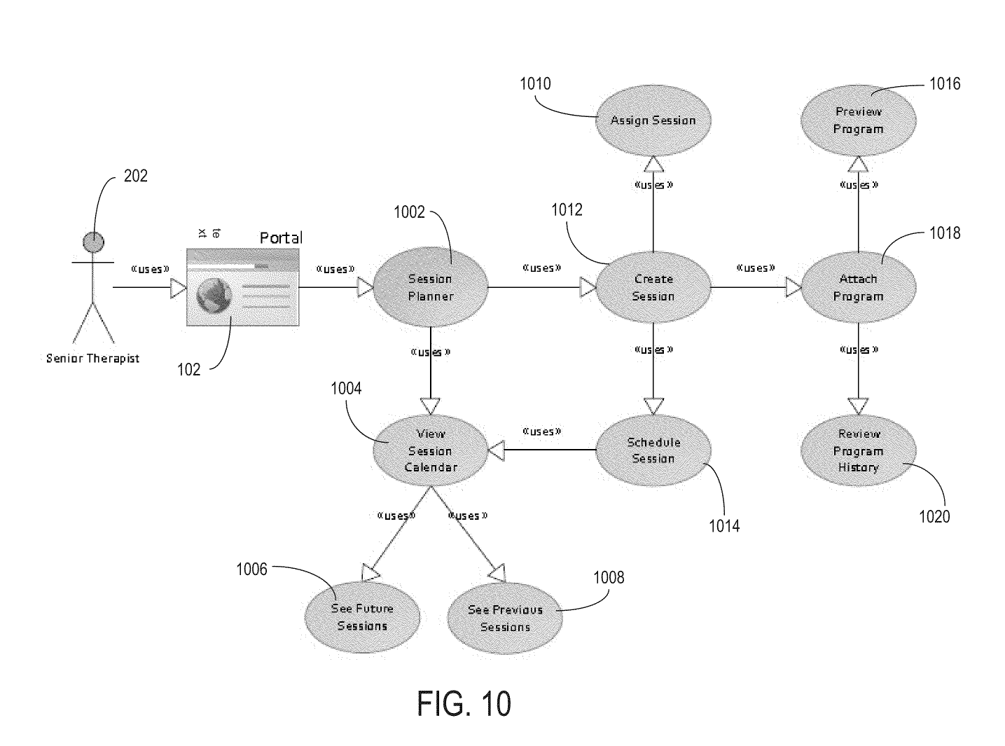

Now referring to FIG. 10, shown is a schematic diagram of a session planner module in accordance with an illustrative embodiment. Here, a senior trainer/therapist 202 interacts with Internet application portal 102 to access a session planner module 1002. The session planner module 1002 provides access to a create session sub-module 1012 to run routines including assign session 1010, attach program 1018, and schedule session 1014. Attaching a program at 1018 may further allow access to a preview program routine 1016 and a review program history routine 1020. The schedule session routine 1014 provides a loop back to the view session calendar sub-module 1004, which allows future sessions 1006 and previous sessions 1008 to be viewed in the calendar.

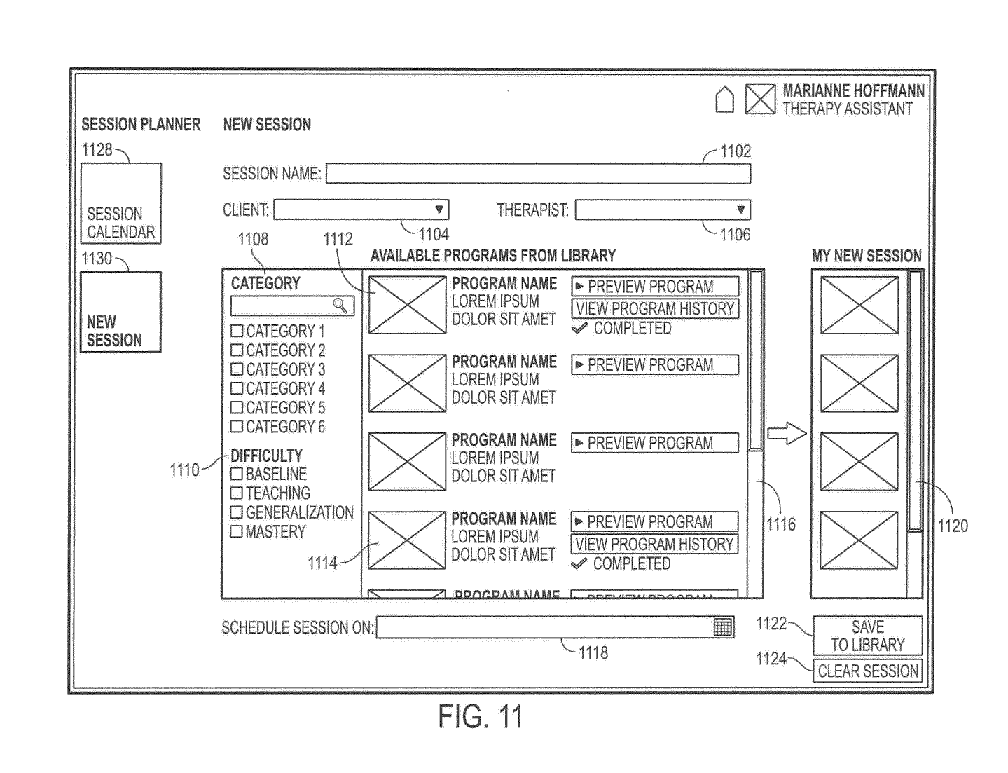

FIG. 11 shows a schematic diagram of a user interface screen for displaying session information for a subject in accordance with an illustrative embodiment. Shown is a new session name input field 1102, and a drop down menu 1104 for selecting a client. Another drop down menu 1104 allows selection of a trainer/therapist. Settings for categories 1108 and difficulty 1110 may be selected to obtain available programs 1112, 1114 from a library 1116, and a session may be scheduled in a calendar at 1118. A new session created for a particular subject may include a plurality of programs for inclusion in the session. Once a new session is created, the session may be saved to a library at 1122 and cleared 1124. Buttons to a session calendar 1128 and a new screen button 1130 to create a new session may also be provided.

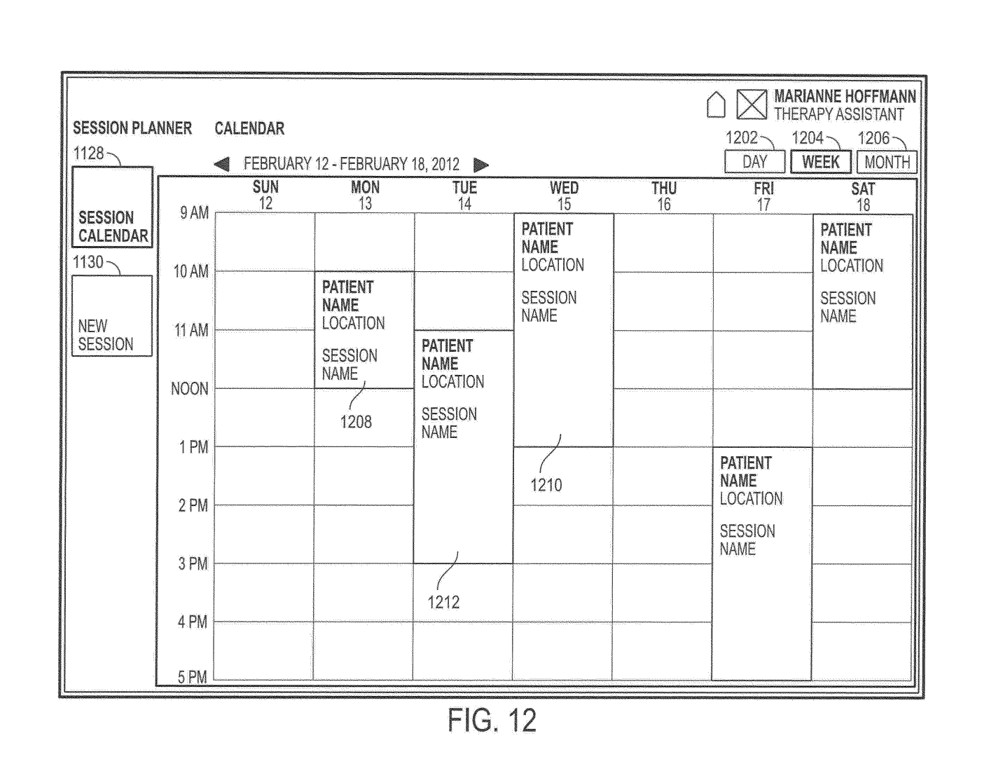

Now referring to FIG. 12, shown is a calendar with various sessions 1208, 1210, 1212 that have been scheduled. Alternative views for a day 1202, week 1204 or month 1206 may be provided to show the schedule for a particular period of time.

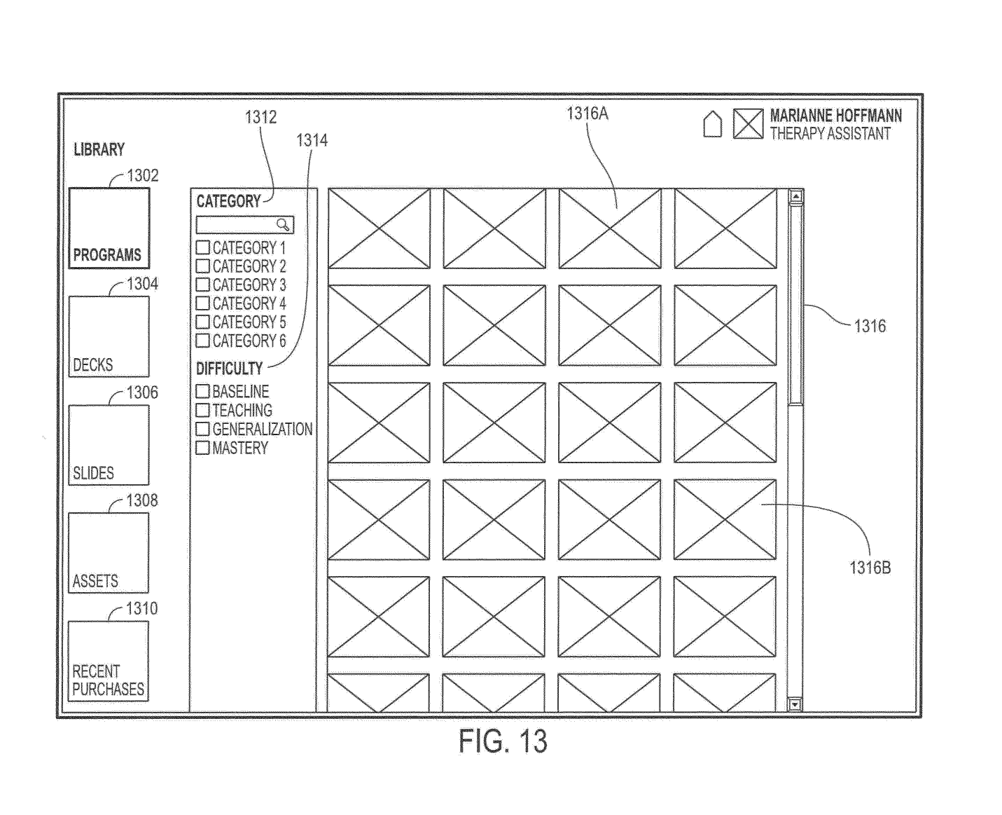

FIG. 13 shows a schematic diagram of a library containing a plurality of sessions in accordance with an illustrative embodiment. As shown, various buttons provide access to programs 1302, decks 1304, slides 1306, assets 1308 and recent purchases 1310. Selection of categories 1312 and a level of difficulty 1314 provide a library 1316 of items 1316A, 11316B for selection.

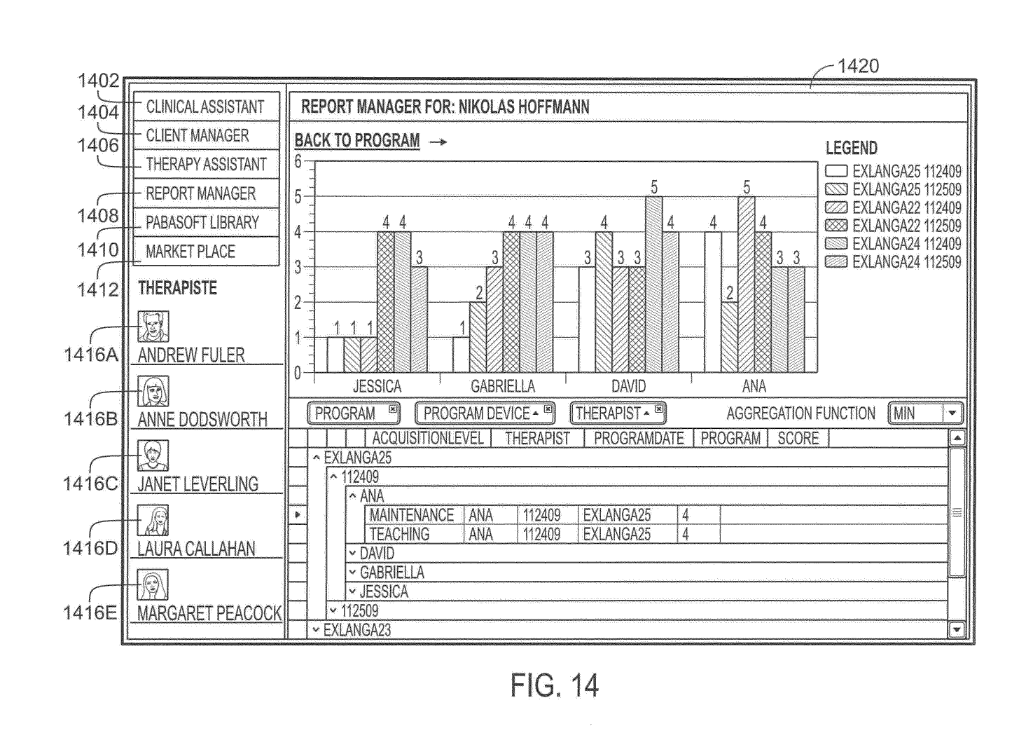

Now referring to FIG. 14, shown is an illustrative graph of performance by the subject based on the trainer/therapist who worked with the subject. Various types of personnel and assets may be tracked, including a clinical assistant 1402, client manager 1404, therapy assistant 1406, report manager 1408, library 1410 and marketplace 1412. Different trainers/therapists 1416A-1416E may be tracked to determine if there is a trend or pattern of scores when the subject is working with a particular trainer/therapist. If it is found that the subject is experiencing more success with a particular trainer/therapist, the interactions can be reviewed on video to determine what type of interaction results in the best responses from the subject. This may be used to further customize the program for the subject.

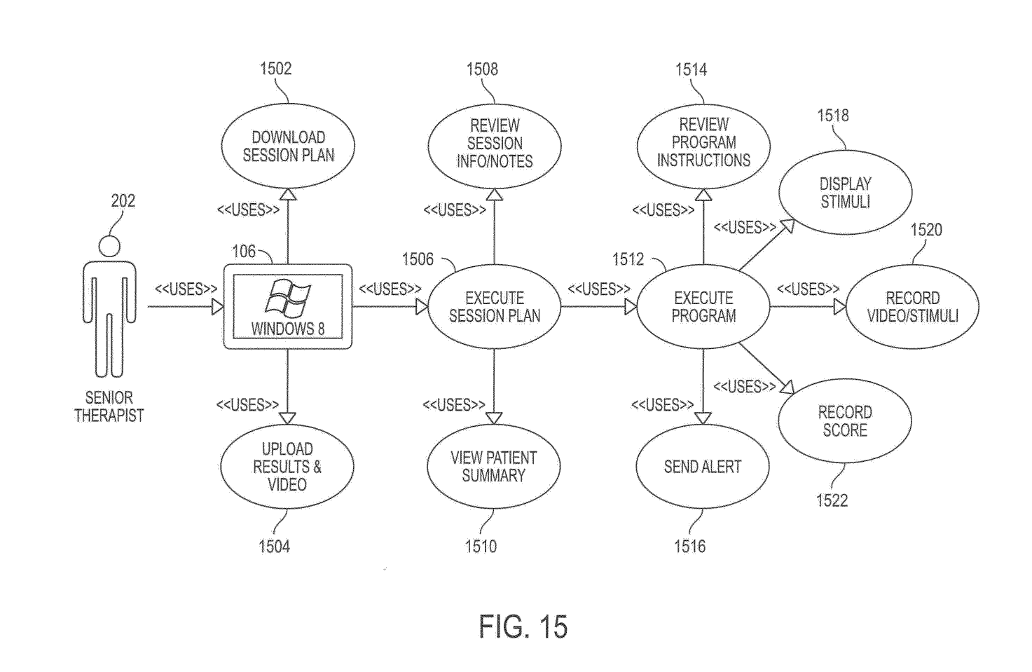

FIG. 15 shows a schematic diagram of a session execution module in accordance with an illustrative embodiment. As shown, a senior trainer/therapist 202 interacts with an application software client interface 102 to access a session plan module 1506 to execute a session. The system enables review of session notes at 1508, and viewing of a patient summary It 15010. The system further includes an execute program module 1512 which allows review of program instructions 1514, display of stimuli 1518, recording video of the stimuli interaction 1520, and recording a score 1522 based on the response. At any time, an alert 1516 may be sent so that the senior trainer/therapist can review a particular interaction to provide further analysis or input.

Thus, in an embodiment, live data can be viewed and analyzed immediately by clinical supervisors, senior Trainers/therapists, or other professionals, while watching live video transmitted from the therapy session. Furthermore, the system allows real time collaboration between professionals using text or emails that can be sent during session to flag issues immediately. Issues and gains can be posted to share progress immediately between team members, and action items can be assigned immediately.

In an embodiment, the system also allows the tracking of funds expended on delivery of therapy programs by allowing any company, agency or person to print a report the effectiveness of the program and the costs to produce that outcome. This allows stakeholders to make changes in the appropriate areas based on hard time stamped data, in comparison to a clinical decision that relies heavily on anecdotal interpretations of behavior.

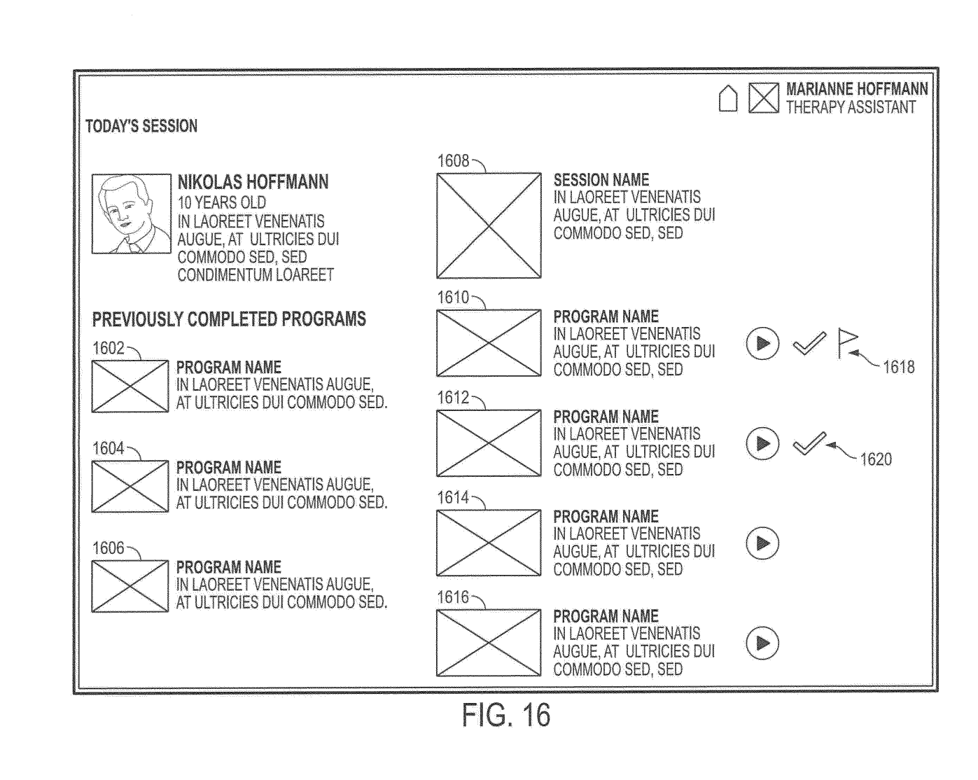

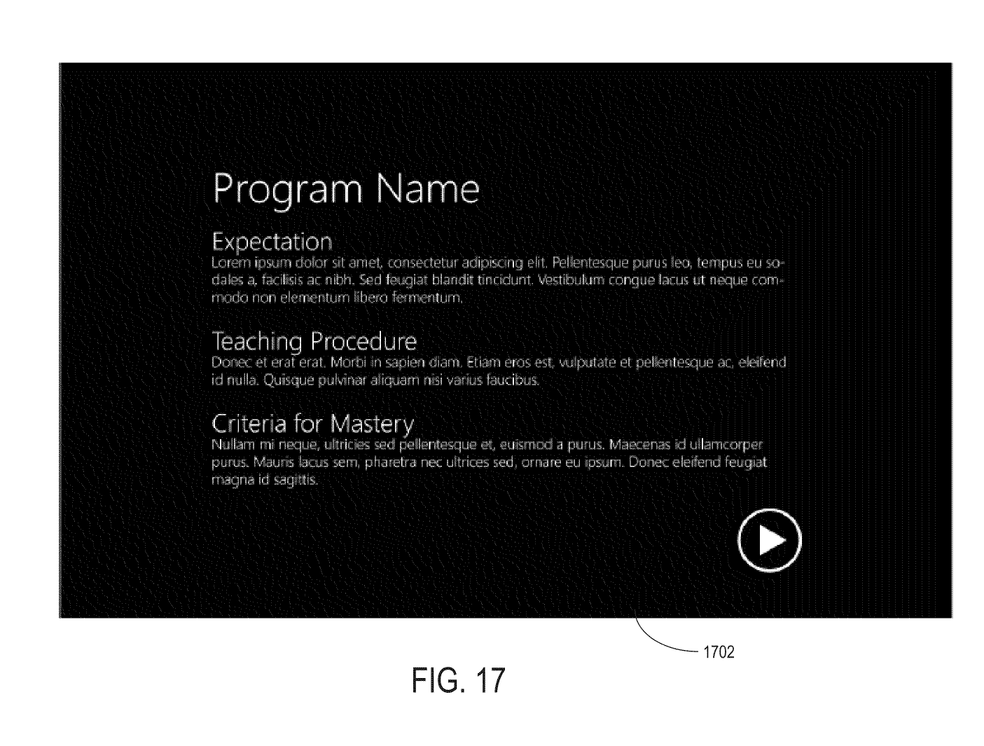

Now referring to FIG. 16, shown is a schematic diagram of a user interface screen for showing the sessions to be undertaken by a subject in accordance with an illustrative embodiment. A session 1608 provides a number of programs 1610, 1612, 1614, 1616 to be completed in the session. Previously completed programs 1602, 1604, 1606 may be noted. For programs 1610, 1612 that have been completed, a checkmark, flag or other indicators 1618, 1620 may be used to denote the status. As shown in FIG. 17, a particular program may include expectations, a teaching procedure, and criteria for mastery.

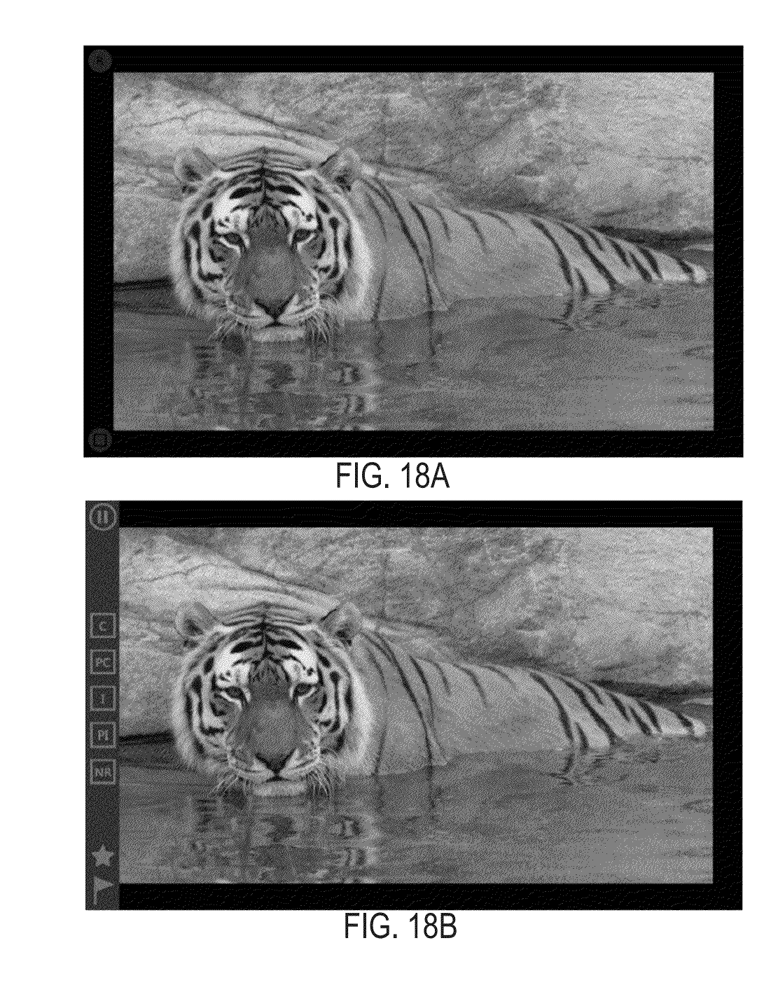

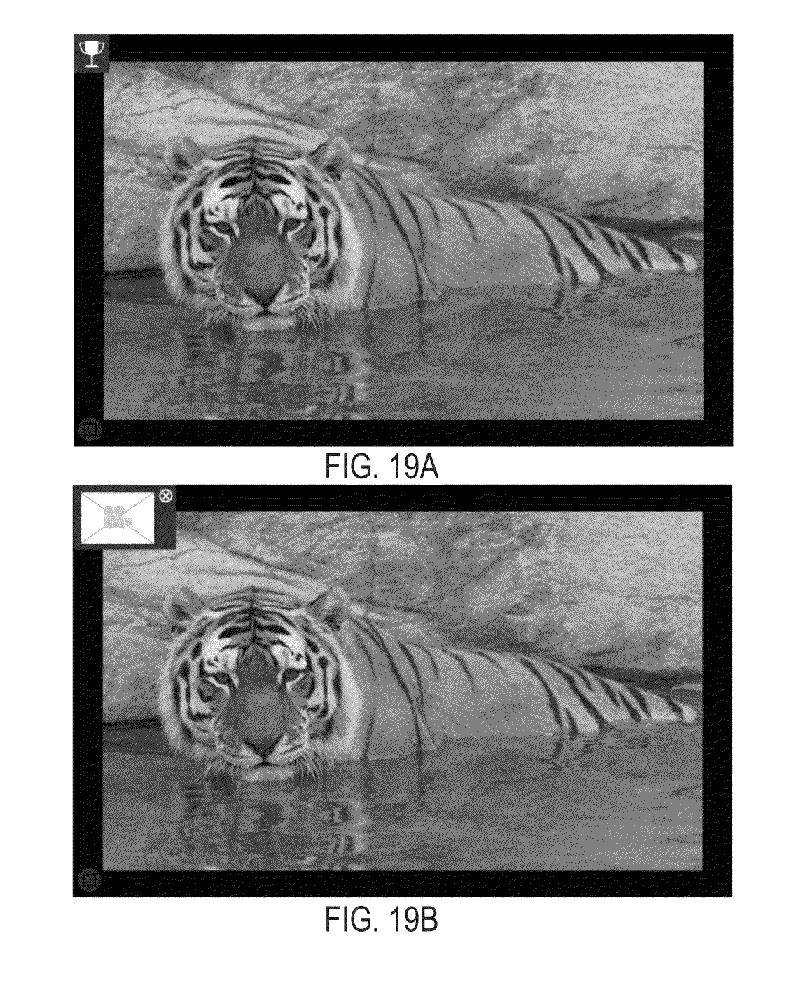

FIGS. 18A and 18B show illustrative examples of stimuli with various interactive features. FIGS. 19A and 19B also shows illustrative examples of stimuli with various interactive features.

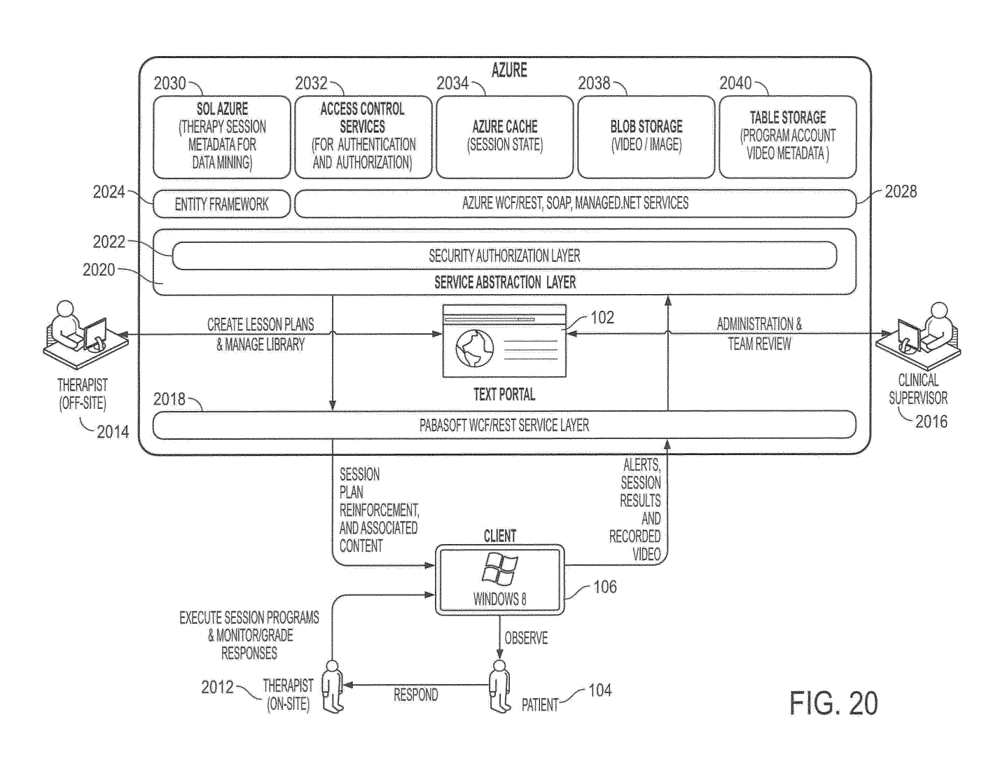

FIG. 20 shows a schematic block diagram of an illustrative application services platform which may provide a suitable application environment, but which is not meant to be limiting. It will be appreciated that other suitable platforms may be built to embody the present system and method. As shown, patient 104 can observe a therapy program via an application software client 106. An on-site trainer/therapist 2012 can execute the session programs and monitor and grade the responses. In an embodiment, data is captured via a touch screen interface, making the therapy sessions less clinical and administrative, and more engaging and social.

In an embodiment, an off-site senior trainer/therapist 2014 can create lesson plans and manage the library, while a clinical supervisor 2016 can attend to administration and team review. Team meetings can now be more meaningful, as key decisions can now be made from hard data accessible to the team and recorded video sessions of the interactions available to interpret. As shown above, data can be measured and charted electronically cross referencing many categories to identify real programming issues. Potential issues can be identified by analyzing any permutation of lesson, date or trainer/therapist, over a specific domain. This allows meaningful data to be used to modify a program or sessions for a subject based on what the subject seems to respond to with the best results.

The system monitors for alerts, session results, and recorded video, and interacts with the application service layer 2018. The application service layer 2018 accesses a service abstraction layer 202 including a security authorization layer 2022. The application services platform may further include an entity framework 2024, and various application services 2028. The application services platform may further include a relational database 2030, access control services 2032, a cache 2034, a Binary Large Object (BLOB) storage 2038, and table storage 2040.

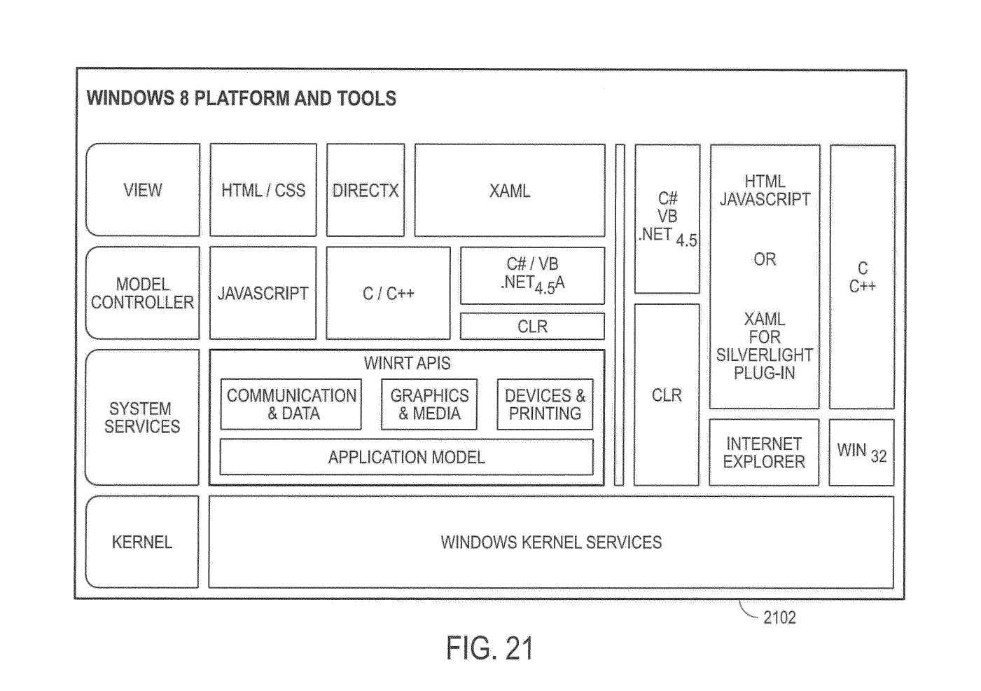

FIG. 21 shows a schematic block diagram of an operating system platform and tools in accordance with an illustrative embodiment. For example, the illustrated Windows 8 Platform and Tools may be used as a suitable operating system platform for the development of the present system and method. However, the present system and method is platform agnostic, and may be implemented on any suitable operating system (including iOS, Windows, Android, etc.) and markup language (e.g. HTML, XHTML, etc.) to accommodate a standalone or server client architecture.

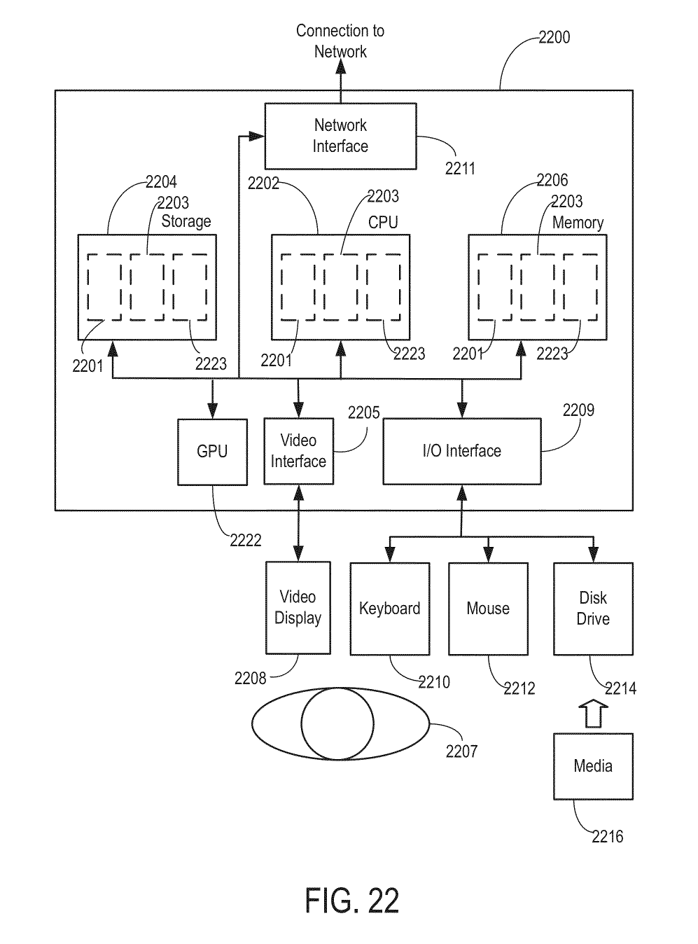

Now referring to FIG. 22, the present system and method may be practiced in various embodiments. A suitably configured generic computer device, and associated communications networks, devices, software and firmware may provide a platform for enabling one or more embodiments as described above. By way of example, FIG. 22 shows a generic computer device 2200 that may include a central processing unit (“CPU”) 2202 connected to a storage unit 2204 and to a random access memory 2206. The CPU 302 may process an operating system 2201, application program 2203, and data 2223. The operating system 2201, application program 2203, and data 2223 may be stored in storage unit 2204 and loaded into memory 2206, as may be required. Computer device 2200 may further include a graphics processing unit (GPU) 2222 which is operatively connected to CPU 2202 and to memory 2206 to offload intensive image processing calculations from CPU 2202 and run these calculations in parallel with CPU 2202. An operator 2207 may interact with the computer device 2200 using a video display 2208 connected by a video interface 2205, and various input/output devices such as a keyboard 2210, mouse 2212, and disk drive or solid state drive 2214 connected by an I/O interface 2209. In known manner, the mouse 2212 may be configured to control movement of a cursor in the video display 2208, and to operate various graphical user interface (GUI) controls appearing in the video display 2208 with a mouse button. The disk drive or solid state drive 2214 may be configured to accept computer readable media 2216. The computer device 2200 may form part of a network via a network interface 2211, allowing the computer device 2200 to communicate through wired or wireless communications with other suitably configured data processing systems (not shown). The generic computer device 2200 may be embodied in various form factors including desktop and laptop computers, and wireless mobile computer devices such as tablets, smart phones and super phones operating on various operating systems. It will be appreciated that the present description does not limit the size or form factor of the computing device on which the present system and method may be embodied.

While the illustrative embodiment described above has focused on a particular application for a system and method for managing the delivery of ABA therapies (e.g. for the treatment of ASD), it will be appreciated that the present system and method may be adapted to many other fields including educational, health care, behavioral training of humans and animals, and various other verticals: For example, the system and method may be adapted to provide therapies to people with other developmental delays or disorders receiving instructional therapies (e.g. Learning Dysfunction), people receiving Speech or Language therapy (SLP) (e.g. Learning Language Disorders), and people receiving Occupational or Physical therapy (OT/PT) (e.g. People who have suffered a stroke). Here, the assessment of a trainer or therapist initiates a flag or time-stamp in the video stream such that all relevant metadata captured during the training/therapy session can be linked to the time-stamp as an assessment event.

As another example, the system and method may be adapted to behavioral or performance training for animals, such as the training of horses or dogs. In this case, the stimulus may be various verbal or visual commands meant to provide the animal with instructions to perform a task or a trick. The response of the animal may then be assessed by the trainer in real time, and the assessment may trigger a time-stamp on the video stream to capture the metadata corresponding to the assessment event.

Thus, as will be appreciated, the above described illustrative example of the system and method is not meant to be limiting.

The system and method also allows collaboration amongst professionals who are required to write patient reports, while reducing the costs involved. The system and method may also be adapted to an educational environment that requires a modified program for their students. It will reduce the time and cost to create reports and be a collaborative tool to assist teachers, parents, administrators and psychologists.

Thus, in an aspect, there is provided a computer-implemented method for managing interactive training, comprising: recording a video stream for a training session having a plurality of stimulus-response events; receiving an assessment for each stimulus-response event based on the subject's interaction with or response to a stimulus; time stamping the stimulus-response assessed event in the video stream and identifying the stimulus used at the time of assessing each stimulus-response event; and providing a user interface including one or more of the assessed stimulus-response events for selection.

In an embodiment, the method further comprises, upon selection of a time stamped stimulus-response event, queuing the video stream at the start of the stimulus-response event for playback of the corresponding video stream together with the stimulus.

In another embodiment, the method further comprises displaying the user interface on a display at a location remote from the training session for the remote playback of video streams of the training session.

In another embodiment, the method further comprises recording the location of the training session and the identity of an on-site trainer performing the stimulus-response assessment.

In another embodiment, the method further comprises providing bi-directional communications between an on-site trainer's computing device and an off-site trainer's computing device to facilitate discussion of an assessment of one or more stimulus-response events, thereby to provide a collaborative environment for assessing the performance of the subject.

In another embodiment, the method further comprises recording the bi-directional communications between the on-site trainer and the off-site trainer to the subject's file to provide a complete record of the assessment of the training session.

In another embodiment, the method further comprises tracking the assessment of stimulus-response events by the on-site trainer, and providing a graphic representation of the performance of the subject when trained by the on-site trainer, thereby to identify differences in performance of the subject when interacting with different on-site trainers.

In another aspect, there is provided a computer-implemented system for managing interactive training, comprising: means for recording a video stream for a training session having a plurality of stimulus-response events; means for receiving an assessment for each stimulus-response event based on the subject's interaction with or response to a stimulus; means for time stamping the assessed stimulus-response event in the video stream and identifying the stimulus used at the time of assessing each stimulus-response event; and means for providing a user interface including one or more of the assessed stimulus-response events for selection.

In an embodiment, the system further comprises means for queuing the video stream, upon selection of a time stamped stimulus-response event, at the start of the stimulus-response event for playback of the corresponding video stream together with the stimulus.

In another embodiment, the system further comprises means for displaying the user interface on a display at a location remote from the training session for the remote playback of video streams of the training session.

In another embodiment, the system further comprises means for recording the location of the training session and the identity of an on-site trainer performing the stimulus-response assessment.

In another embodiment, the system further comprises means for providing bi-directional communications between an on-site trainer's computing device and an off-site trainer's computing device to facilitate discussion of the assessment of one or more stimulus-response events, thereby to provide a collaborative environment for assessing the performance of the subject.

In another embodiment, the system further comprises means for recording the bi-directional communications between the on-site trainer and the off-site trainer to the subject's file to provide a complete record of the assessment of the training session.

In another embodiment, the system further comprises means for tracking the assessment of stimulus-response events by the on-site trainer, and providing a graphic representation of the performance of the subject when trained by the on-site trainer, thereby to identify differences in performance of the subject when interacting with different on-site trainers.

In another aspect, there is provided a non-transitory computer-readable medium storing computer readable code that when executed on one or more computing devices adapts the devices to perform a method for managing interactive training, the non-transitory computer readable medium comprising: code for recording a video stream for a training session with a plurality of stimulus-response events; code for receiving an assessment for each stimulus-response event based on the subject's interaction with or response to a stimulus; code for time stamping the assessed stimulus-response event in the video stream and identifying the stimulus used at the time of assessing each stimulus-response event; and code for providing a user interface including the assessed stimulus-response events for selection.

In an embodiment, the non-transitory computer readable medium further comprises code for queuing, upon selection of a time stamped stimulus-response event, the video stream at the start of the stimulus-response event for playback of the corresponding video stream together with the stimulus.

In another embodiment, the non-transitory computer readable medium further comprises code for displaying the user interface on a display at a location remote from the training session for the remote playback of video streams of the training session.

In another embodiment, the non-transitory computer readable medium further comprises code for recording the location of the training session and the identity of an on-site trainer performing the stimulus-response assessment.

In another embodiment, the non-transitory computer readable medium further comprises code for providing bi-directional communications between an on-site trainer's computing device and an off-site trainer's computing device to facilitate discussion of one or more stimulus-response assessment events, thereby to provide a collaborative environment for assessing the performance of the subject.

In another embodiment, the non-transitory computer readable medium further comprises code for recording the bi-directional communications between the on-site trainer and the off-site trainer to the subject's file to provide a complete record of the assessment of the training session.

In another embodiment, the non-transitory computer readable medium further comprises code for tracking the assessment of stimulus-response events by the on-site trainer, and providing a graphic representation of the performance of the subject when trained by the on-site trainer, thereby to identify differences in performance of the subject when interacting with different on-site trainers.

While illustrative embodiments of the invention have been described above, it will be appreciate that various changes and modifications may be made without departing from the scope of the present invention.

### REFERENCES

Baer, D., Wolf, M., & Risley, R. (1968). Some current dimensions of applied behavior analysis. Journal of Applied Behavior Analysis, 1, 91-97. Baer, D., Wolf, M., & Risley, R. (1987). Some still-current dimensions of applied behavior analysis. Journal of Applied Behavior Analysis , 20, 313-327.

Sulzer-Azaroff, B. & Mayer, R. (1991). Behavior analysis for lasting change Fort Worth, Tex.: Holt, Reinhart & Winston, Inc.

1. A computer-implemented method for managing interactive training, comprising:
recording a video stream for a training session having a plurality of stimulus-response events;
receiving an assessment for each stimulus-response event based on the subject's interaction with or response to the stimulus;
time stamping the assessed stimulus-response event in the video stream and identifying the stimulus used at the time of assessing each stimulus-response event; and
providing a user interface including one or more of the assessed stimulus-response events for selection.

2. The method of claim 1, further comprising, upon selection of a time stamped stimulus-response event, queuing the video stream at the start of the stimulus-response event for playback of the corresponding video stream together with the stimulus.

3. The method of claim 1, further comprising displaying the user interface on a display at a location remote from the training session for the remote playback of video streams of the training session.

4. The method of claim 1, further comprising recording the location of the training session and the identity of an on-site trainer performing the stimulus-response assessment.

5. The method of claim 4, further comprising providing bi-directional communications between an on-site trainer's computing device and an off-site trainer's computing device to facilitate discussion of an assessment of one or more stimulus-response events, thereby to provide a collaborative environment for assessing the performance of the subject.

6. The method of claim 5, further comprising recording the bi-directional communications between the on-site trainer and the off-site trainer to the subject's file to provide a complete record of the assessment of the training session.

7. The method of claim 1, further comprising tracking the assessment of stimulus-response events by the on-site trainer, and providing a graphic representation of the performance of the subject when trained by the on-site trainer, thereby to identify differences in performance of the subject when interacting with different on-site trainers.

8. A computer-implemented system for managing interactive training, comprising:
means for recording a video stream for a training session having a plurality of stimulus-response events;
means for receiving an assessment for each stimulus-response event based on the subject's interaction with or response to a stimulus;
means for time stamping the assessed stimulus-response event in the video stream and identifying the stimulus used at the time of assessing each stimulus-response event; and
means for providing a user interface including one or more of the assessed stimulus-response events for selection.

9. The system of claim 8, further comprising means for queuing the video stream, upon selection of a time stamped stimulus-response event, at the start of the stimulus-response event for playback of the corresponding video stream together with the stimulus.

10. The system of claim 9, further comprising means for displaying the user interface on a display at a location remote from the training session for the remote playback of video streams of the training session.

11. The system of claim 8, further comprising means for recording the location of the training session and the identity of an on-site trainer performing the stimulus-response assessment.

12. The system of claim 11, further comprising means for providing bi-directional communications between an on-site trainer's computing device and an off-site trainer's computing device to facilitate discussion of the assessment of one or more stimulus-response events, thereby to provide a collaborative environment for assessing the performance of the subject.

13. The system of claim 12, further comprising means for recording the bi-directional communications between the on-site trainer and the off-site trainer to the subject's file to provide a complete record of the assessment of the training session.

14. The system of claim 8, further comprising means for tracking the assessment of stimulus-response events by the on-site trainer, and providing a graphic representation of the performance of the subject when trained by the on-site trainer, thereby to identify differences in performance of the subject when interacting with different on-site trainers.

15. A non-transitory computer-readable medium storing computer readable code that when executed on one or more computing devices adapts the devices to perform a method for managing interactive training, the non-transitory computer readable medium comprising:
code for recording a video stream for a training session with a plurality of stimulus-response events;
code for receiving an assessment for each stimulus-response event based on the subject's interaction with or response to a stimulus;
code for time stamping the assessed stimulus-response event in the video stream and identifying the stimulus used at the time of assessing each stimulus-response event; and
code for providing a user interface including one or more of the assessed stimulus-response events for selection.

16. The non-transitory computer readable medium of claim 15, further comprising code for queuing, upon selection of a time stamped stimulus-response event, the video stream at the start of the stimulus-response event for playback of the corresponding video stream together with the stimulus.

17. The non-transitory computer readable medium of claim 16, further comprising code for displaying the user interface on a display at a location remote from the training session for the remote playback of video streams of the training session.

18. The non-transitory computer readable medium of claim 15, further comprising code for recording the location of the training session and the identity of an on-site trainer performing the stimulus-response assessment.

19. The non-transitory computer readable medium of claim 15, further comprising code for providing bi-directional communications between an on-site trainer's computing device and an off-site trainer's computing device to facilitate discussion of one or more stimulus-response assessment events, thereby to provide a collaborative environment for assessing the performance of the subject.

20. The non-transitory computer readable medium of claim 19, further comprising code for recording the bi-directional communications between the on-site trainer and the off-site trainer to the subject's file to provide a complete record of the assessment of the training session.

21. The non-transitory computer readable medium of claim 19, further comprising code for tracking the assessment of stimulus-response events by the on-site trainer, and providing a graphic representation of the performance of the subject when trained by the on-site trainer, thereby to identify differences in performance of the subject when interacting with different on-site trainers.
